(19) United States
(12) Patent Application Publication
(10) Pub. No.: US 2020/0245603 A1
(43) Pub. Date: Aug. 6, 2020

(54) Fish Hook With Rigging Loop

(71) Applicant: Randy Hummel, Windom, MN (US)

(72) Inventor: Randy Hummel, Windom, MN (US)

(21) Appl. No.: 16/776,974

(22) Filed: Jan. 30, 2020

Related U.S. Application Data
(60) Provisional application No. 62/799,243, filed on Jan. 31, 2019.

(51) Int. Cl. A01K 91/04; A01K 83/00

(52) U.S. Cl. CPC A01K 91/04; A01K 83/00

(57) ABSTRACT

A fish hook with rigging loop facilitates hooking up a series of hooks into a desired fishing rig configuration. The assembly includes a hook having a shaft and a hook portion. The hook portion is planar and extends from a bottom of the shaft. A wire has a top end coupled to the shaft adjacent to a distal end of the shaft relative to the hook portion. The wire has a bottom end coupled to the shaft between the top end and the hook portion wherein the wire forms a loop with the shaft.

### CROSS-REFERENCE TO RELATED APPLICATIONS

I hereby claim the benefit under 35 U.S.C. Section 119(e) of U.S. Provisional application 62/799,243 filed on Jan. 31, 2019.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to fish hooks and more particularly pertains to a new fish hook for facilitating hooking up a series of hooks into a desired fishing rig configuration.

### (2) Description of Related Art Including Information Disclosed Under 37 CFR 1.97 and 1.98

The prior art relates to fish hooks. Known prior art fails to disclose a rigging loop as provided for in the present invention.

### BRIEF SUMMARY OF THE INVENTION

An embodiment of the disclosure meets the needs presented above by generally comprising a hook having a shaft and a hook portion. The hook portion is planar and extends from a bottom of the shaft. A wire has a top end coupled to the shaft adjacent to a distal end of the shaft relative to the hook portion. The wire has a bottom end coupled to the shaft between the top end and the hook portion wherein the wire forms a loop with the shaft.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a side view of a fish hook with rigging loop according to an embodiment of the disclosure.

FIG. 2 is a side view of an embodiment of the disclosure in a conventional attachment to a fishing line.

FIG. 3 is a side view of two hook rig according to an embodiment of the disclosure.

FIG. 4 is an unassembled side view of components of a three hook rig according to an embodiment of the disclosure.

FIG. 5 is a side view of a three hook rig according to an embodiment of the disclosure.

FIG. 6 is a side view of an alternative embodiment of the disclosure.

FIG. 7 is a side view of an alternative embodiment of the disclosure.

### DETAILED DESCRIPTION OF THE INVENTION

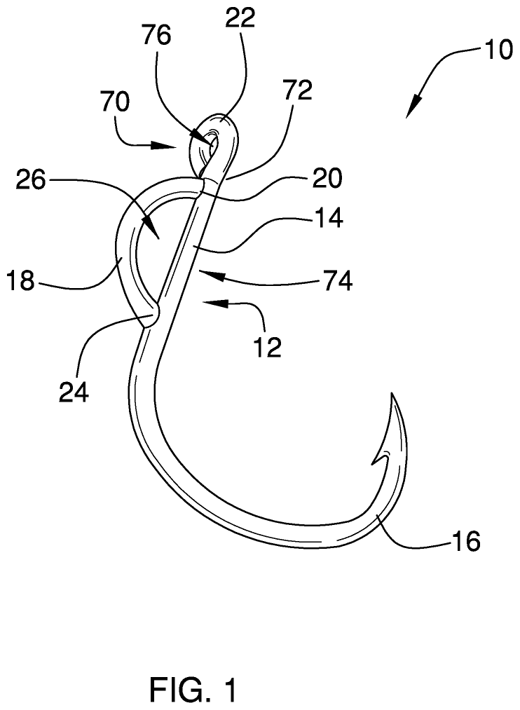

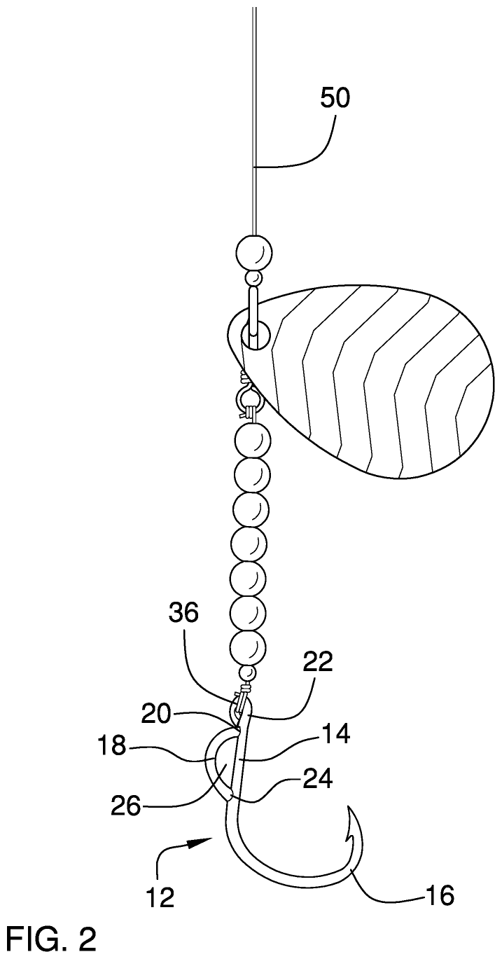

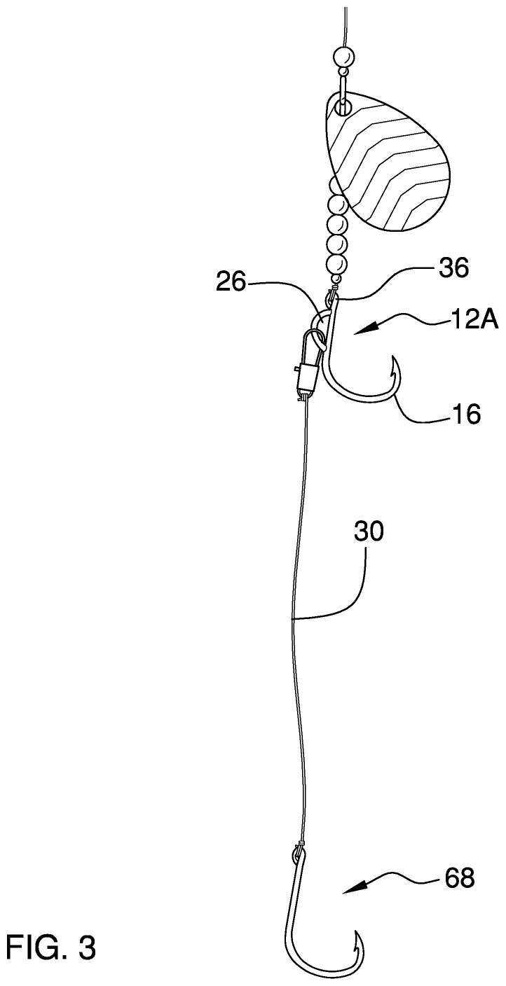

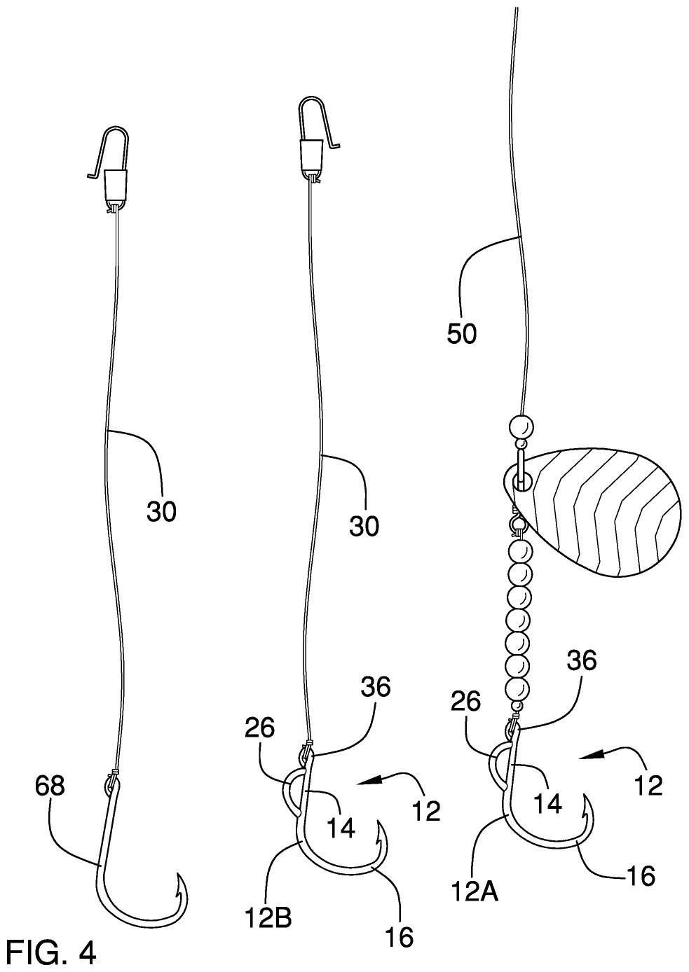

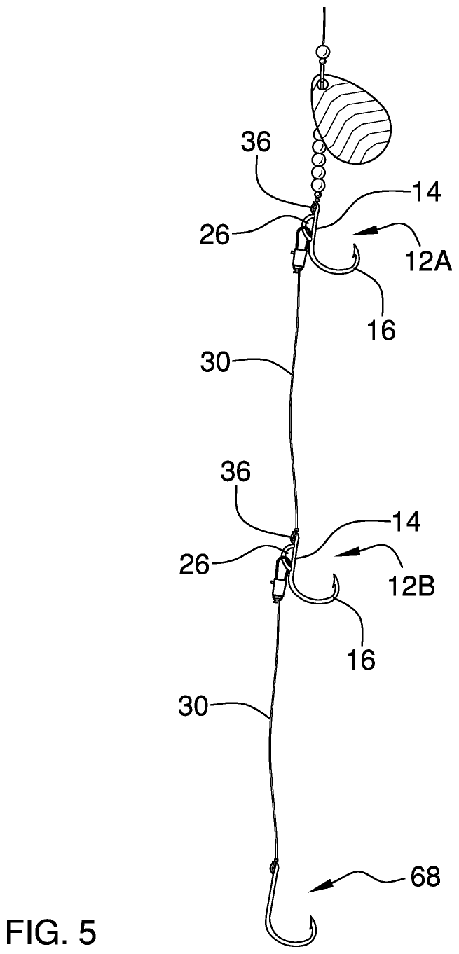

With reference now to the drawings, and in particular to FIGS. 1 through 7 thereof, a new fish hook embodying the principles and concepts of an embodiment of the disclosure and generally designated by the reference numeral 10 will be described.

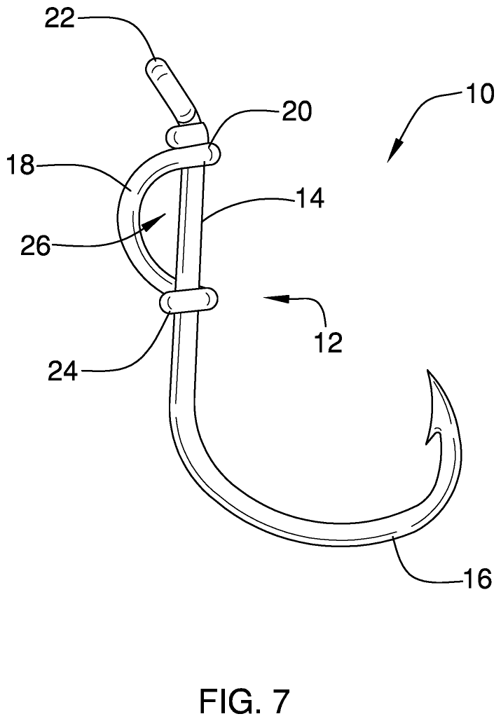

As best illustrated in FIGS. 1 through 7, the fish hook with rigging loop 10 generally comprises a hook 12 having a shaft 14 and a hook portion 16. The hook portion 16 is planar and extends from a bottom of the shaft 14. A wire 18 has a top end 20 coupled to the shaft 14 adjacent to a distal end 22 of the shaft 14 relative to the hook portion 16. The wire 18 has a bottom end 24 coupled to the shaft 14 between the top end 20 and the hook portion 16 wherein the wire 18 forms a loop 26 with the shaft 14. The loop 26 may be integrally formed from the shaft or, as shown in FIG. 7, defined by a continuation of the hook 12 from the distal end 22 of the shaft 14 being bent to wrap around the shaft 14, extend out away from and then back towards the shaft 14, and then wrapped around the shaft 14 forming the bottom end 24. Further, the loop 26 may be added on to an existing conventional hook using any conventional attachment method such as welding, adhesive, bonding, or the like. The hook portion 16 may also have a barb in the manner of a conventional fish hook.

As shown in FIGS. 1 through 5, the hook portion 16 may be coplanar with the loop 26 meaning the hook 12 can be laid substantially flat with the hook portion 16 and the wire 18 laying on a common flat surface with the shaft 14 (but for any protrusion in the wrapping of the wire 18 if present). Further, the hook portion 16 is shaped to extend from the shaft 14 in a first direction and the loop 26 extends from the shaft 14 in a second direction opposite the first direction. Thus, the hook portion 16 and loop 26 are positioned on diametrically opposed sides of the shaft 14.

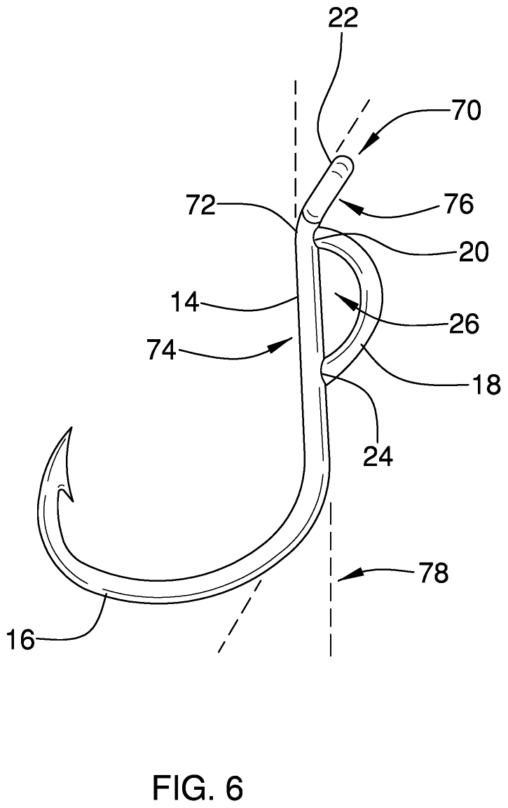

As shown in FIG. 6, the hook portion 16 may be curved within a plane with the plane being angled relative to the shaft 14. Thus, the shaft 14 extends outwardly and away from said plane.

A ring 70 is positioned at the distal end 22 of the shaft 14. The shaft 14 has a bend 72 such that the ring 70 is angled to extend away from a longitudinal axis 78 of a main portion 74 of the shaft 14. The ring 70 extends in the same direction to be aligned with the loop 26 along the shaft 14. An opening 76 through the ring 70 is perpendicular to the loop 26 such that the opening 76 faces the loop 26.

In use, an initial hook 12A is connected to a fishing line 50 in a conventional manner using a conventionally positioned line connector 36. A second hook 12B may be attached to the initial hook 12A in series by a first end 28 of a connection line 30 being tied, clipped, or otherwise connected to the initial hook 12A using the loop 26. A second end 32 of the connection line 30 is coupled to the conventionally positioned line connector 36 on the adjacently positioned second hook 12B. A conventional fish hook 68 may be prepared and connected to be a final hook in the series as the loop 26 would not be needed for subsequent engagement or connection of another hook. While three total hooks are provided in the description and annexed drawings/photos, a series of any desired number of hooks may be achieved. Further, where time may be a factor and conditions may change while fishing, such as during a fishing competition, additional accessories may be incorporated on the connection line 30 and/or hooks in a conventional manner, if desired, and a several separate rigs each incorporating a customized series of hooks may be pre-assembled and then quickly selected, attached to, or removed from a fishing pole.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A fish hook assembly comprising:
a hook having a shaft and a hook portion, said hook portion being planar and extending from a bottom of said shaft; and
a wire having a top end coupled to said shaft adjacent to a distal end of said shaft relative to said hook portion, said wire having a bottom end coupled to said shaft between said top end and said hook portion wherein said wire forms a loop with said shaft.

2. The assembly of claim 1, further comprising said hook portion being coplanar with said loop.

3. The assembly of claim 2, further comprising said hook portion being shaped to extend from said shaft in a first direction, said loop extending from said shaft in a second direction opposite said first direction.

4. The assembly of claim 1, further comprising said hook being curved within a plane, said plane being angled relative to said shaft wherein said shaft extends outwardly and away from said plane.

5. The assembly of claim 1, further comprising a ring positioned at said distal end of said shaft, said shaft having a bend such that said ring is angled to extend away from a longitudinal axis of a main portion of said shaft.

6. The assembly of claim 5, further comprising said ring extending in the same direction from said shaft as said loop wherein said ring is aligned with said loop along the shaft.

7. The assembly of claim 6, further comprising an opening through said ring being perpendicular to said loop such that said opening faces said loop.

8. A fish hook assembly comprising:
a hook having a shaft and a hook portion, said hook portion being planar and extending from a bottom of said shaft; and
a wire having a top end coupled to said shaft adjacent to a distal end of said shaft relative to said hook portion, said wire having a bottom end coupled to said shaft between said top end and said hook portion wherein said wire forms a loop with said shaft, said hook portion being coplanar with said loop, said hook portion being shaped to extend from said shaft in a first direction, said loop extending from said shaft in a second direction opposite said first direction.

9. A fish hook assembly comprising:
a hook having a shaft and a hook portion, said hook portion being planar and extending from a bottom of said shaft;
a wire having a top end coupled to said shaft adjacent to a distal end of said shaft relative to said hook portion, said wire having a bottom end coupled to said shaft between said top end and said hook portion wherein said wire forms a loop with said shaft, said hook being curved within a plane, said plane being angled relative to said shaft wherein said shaft extends outwardly and away from said plane;
a ring positioned at said distal end of said shaft, said shaft having a bend such that said ring is angled to extend away from a longitudinal axis of a main portion of said shaft, said ring extending in the same direction from said shaft as said loop wherein said ring is aligned with said loop along the shaft; and
an opening through said ring being perpendicular to said loop such that said opening faces said loop.
